(19) United States
(12) Patent Application Publication
(10) Pub. No.: US 2007/0202852 A1
(43) Pub. Date: Aug. 30, 2007

(54) Input method and arrangement for portable electronic device

(75) Inventor: Kai-Wu Li, Shanghai City (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/520,722

(22) Filed: Sep. 14, 2006

(30) Foreign Application Priority Data
Feb. 8, 2006 (TW) 095104154

(51) Int. Cl. H04Q 7/38; H04Q 7/22; H04M 3/42

(52) U.S. Cl. 455/414.1

(57) ABSTRACT

The present invention is to provide an input method and arrangement for a portable electronic device installed with a software for showing a virtual disk on a screen on a phone body of the portable electronic device, wherein the virtual disk includes a plurality of fixed marks along its periphery and each of the fixed marks represents a numeral, a character, or a letter. Thus, while inputting a movement signal by manipulating a control button on the phone body will move a moving mark on the periphery of the virtual disk from the fixed mark labeled as an origin to a location desired by a user along the fixed marks. Furthermore, a corresponding one of the fixed marks is activated to generate a corresponding numeral, character, or letter. Then the moving mark returns to the fixed mark labeled as an origin after traversing the periphery of the virtual disk.

### FIELD OF THE INVENTION

The present invention relates to input methods and arrangements and more particularly to an input method and an input arrangement for a portable electronic device with improved characteristics.

### BACKGROUND OF THE INVENTION

The Internet and communications technologies have known a rapid, spectacular development in recent years. A wide variety of devices for the Internet and communications are commercially available constantly. Further, these devices are widely used in our daily life and work. Such trend not only increases the speed and the efficiency of information communications but also brings a lot of convenience to our life and work.

A wide variety of portable electronic devices are commercially available as electronics makes progress significantly. These portable electronic devices include, but not limited to, a number of consumer electronic products such as PDAs (Personal Digital Assistants), mobile phones, and pocket PCs. These products are compact, slim, lightweight, and inexpensive. Further, a number of additional features are added into the products. Thus, the current consumer electronic products not only have a number of conventional features including mobile phone and electronic notebook but also have a number of advanced wireless data communications features including high speed access to the Internet, video game downloading, and e-shopping. In brief, the past illusive Internet and wireless communications services finally come true and these services are further constantly provided to most people in their daily life and work.

Additionally, science and technologies have made progress significantly in recent several decades with living quality improved accordingly. This in turn causes more people to pay attention to their living condition and working environment. In fact, for a mobile user the above portable electronic devices are more portable as compared with notebook computers. Further, the portable electronic devices are easy to operate, can provide financial, banking, and living information, and can serve as a PIM (personal information management). Furthermore, the portable electronic devices have features including schedule, notebook, address book, calculator, and interconnecting a PC and a notebook computer for communicating data in duplex. For a latest type of PDA, it can connect to a mobile phone by wireless, access to the Internet for retrieving information from millions of sources, and receive data from GPS (Global Positioning System).

A new type of the portable electronic device is a pocket PC phone. A user may operate the pocket PC phone in one of two modes as detailed below. The first one as the dominating operating mode of the pocket PC phone involves operating a touch screen thereof. The second mode as a quick auxiliary operation involves operating a navigation button thereof. However, both hands are required to achieve any single operation of the pocket PC phone.

Another new type of portable electronic device is a smart phone. A user can use one hand to operate the smart phone. Thus, a user can conveniently operate the smart phone. However, a user has to use two hands to achieve a single operation of the pocket PC phone. This is not desired. For example, a user wants to dial by means of the pocket PC phone. However, for the pocket PC phone such simple routine dialing operation cannot be done by one hand. This is because no numeric keypad for single hand operation is provided on the pocket PC phone. As a result, its operation is troublesome.

Additionally, the navigation button of the pocket PC phone is shaped as a square. The navigation button comprises four direction keys and a central confirmation key (e.g., “OK” key). However, the navigation button is not sensitive to touch since it is a mechanical device.

In view of the above, the inventor is aware of the problem and is dedicated to meet market needs. The inventor thus spends a lot of time on the improvement of the navigation button of the pocket PC phone. A result of my research and development is the incorporation of a touch sensitive rotary unit into the navigation button. The touch sensitive rotary unit can be manipulated in a manner similar to manipulating dial of a typical telephone. Thus, a user can dial by means of a single hand. Advantageously, manufacturers of the art can have an edge in this competitive market by manufacturing the device and using the method disclosed by the invention. These are the causes of the invention.

### SUMMARY OF THE INVENTION

After considerable research and experimentation, an input method and an input arrangement for a portable electronic device according to the present invention has been devised so as to overcome the above drawback of the prior art (i.e., for the pocket PC phone a simple routine dialing operation is required to be done by both hands, and this is more inconvenient and less desirable as compared with the smart phone) and bring convenience to vast users.

It is an object of the present invention to provide a touch sensitive rotary unit to a control button of a portable electronic device (e.g., a pocket PC phone connectable to a mobile phone) such that a user can use a single hand dialing operation to input numerals, characters, or text.

To achieve the above and other objects, the present invention installs a software in the portable electronic device such that running the software to cause the portable electronic device to enter a disk dialing mode will show a virtual disk on a screen on a phone body of the portable electronic device wherein the virtual disk includes a plurality of fixed marks along its periphery, each of the fixed marks representing a numeral, a character, or a letter. Further, inputting a movement signal by manipulating a control button on the phone body will move a moving mark on the periphery of the virtual disk from the fixed mark labeled as an origin to a location desired by a user along the fixed marks. Furthermore, a corresponding one of the fixed marks is activated to generate a corresponding numeral, character, or letter. Then the moving mark returns to the fixed mark labeled as an origin after traversing the periphery of the virtual disk. As an end, the purpose of dialing operation is achieved.

The above and other objects, features and advantages of the present invention will become apparent from the following detailed description taken with the accompanying drawings.

### BRIEF DESCRIPTION OF THE DRAWINGS

FIG. 1 is a top plan view of a preferred embodiment of portable electronic device according to the invention; and

FIG. 2 is a flowchart depicting a process for dialing according to the invention.

### DETAILED DESCRIPTION OF THE PREFERRED EMBODIMENTS

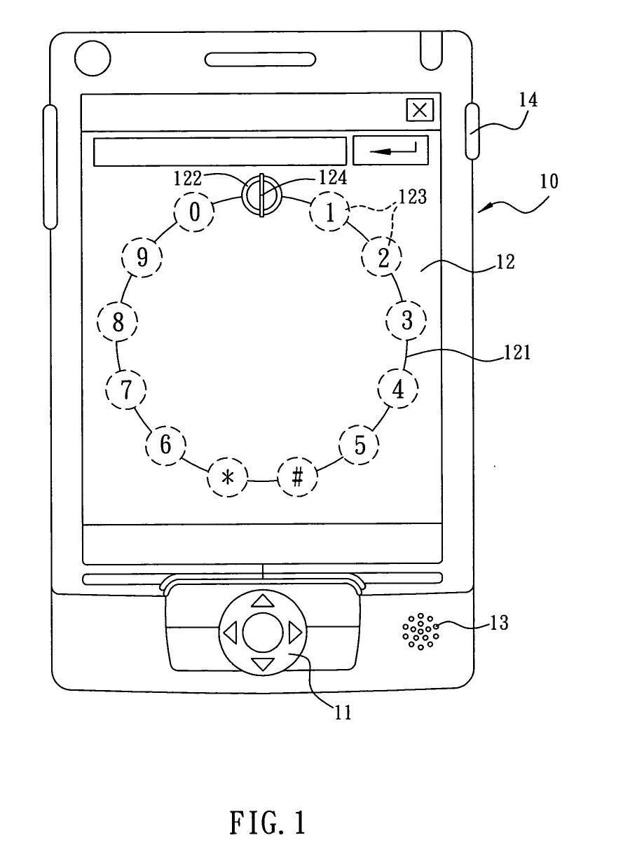

The invention is directed to an input method and an input arrangement for a portable electronic device. Referring to FIG. 1, an input arrangement for a portable electronic device in accordance with a preferred embodiment of the invention is shown. The portable electronic device (e.g., a pocket PC phone connectable to a mobile phone) comprises a phone body 10. On the phone body 10 there are provided a control button 11, a screen 12, a speaker 13, and a hot key 14 in which both the speaker 13 and the hot key 14 are preferably provided. Each component is discussed in detailed below.

The control button 11 is a spherical member and is implemented as a touch sensitive rotary unit. The control button 11 comprises four direction keys and a central confirmation key (e.g., “OK” key). The control button 11 is sensitive to rotation by touching. In operating the electronic device, a user may use one hand to rotate the control button 11. A moving direction of the control button 11 (e.g., clockwise or counterclockwise rotation) can be determined by locating a start point and an end point of the movement. This is similar to making a dial on a typical telephone. As an end, the purpose of inputting a movement signal can be achieved by means of one hand dialing. The screen 12 is adapted to display messages. One exemplary example of the message is a virtual disk 121 (see FIG. 1). The speaker 13 is adapted to amplify sound to a desired volume. The sound can be a dialing sound generated by rotating the virtual disk 121. The hot key 14 is adapted to allow a user to select to enter a disk dialing mode or not.

After equipping the invention with the above hardware components, software is also installed in the electronic device for cooperating with hardware. In use, a user may press the hot key 14 to run the software to enter the disk dialing mode. A virtual disk 121 is then shown on the screen 12 of the electronic device (see FIG. 1). A plurality of fixed marks 123 are shown along a periphery of the virtual disk 121. The fixed marks 123 are comprised of numerals and characters. As shown, for example, there are “origin”, “1”, “2”, “3”, “4”, “5”, “#”, “*”, “6”, “7”, “8”, “9”, and “0” arranged clockwise. After user inputting a movement signal by manipulating the control button (the control button is a spring biased member) 11 and the movement signal is then received by the electronic device, a moving mark (e.g., red point) 122 on the periphery of the virtual disk 121 moves from the “origin” 124 on the periphery of the virtual disk 121 to a desired location along the fixed marks 123. A corresponding fixed mark 123 is activated after receiving a confirmation signal from user by manipulating the control button 11. And in turn, a corresponding numeral or character is generated. Further, the moving mark 122 returns to the “origin” 124 after traversing the periphery of the virtual disk 121. At the same time, for example, the speaker 13 makes a dialing sound similar to the conventional dialing sound of a telephone. By configuring as above, a user can achieve the purpose of dialing by means of the control button 11 and the virtual disk 121.

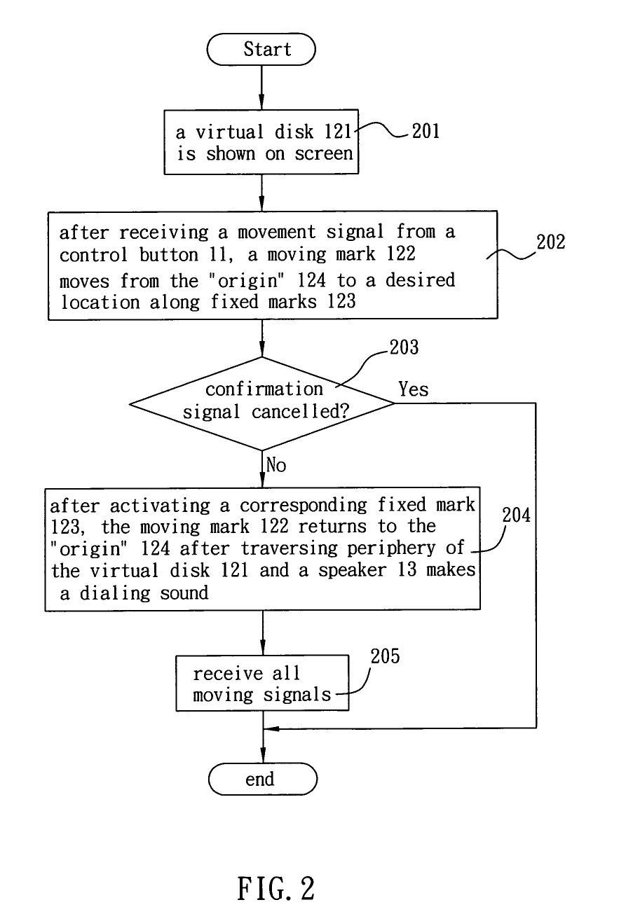

Referring to FIG. 2, it is a flowchart depicting a process for dialing after running the software of the electronic device and a user selecting to enter the disk dialing mode. The electronic device performs the following steps:

Step 201: A virtual disk 121 is shown on the screen 12. A plurality of fixed marks 123 are shown along a periphery of the virtual disk 121.

Step 202: After user inputting a movement signal by manipulating the control button 11 and the movement signal is then received by the electronic device, a moving mark 122 on the periphery of the virtual disk 121 moves from the “origin” 124 to a desired location along the fixed marks 123.

Step 203: The electronic device determines whether a confirmation signal is cancelled or not. If yes, the process ends successfully. Otherwise, the process goes to step 204.

Step 204: A corresponding numeral or character is generated after activating a corresponding fixed mark 123. Further, the moving mark 122 returns to the “origin” 124 after traversing the periphery of the virtual disk 121. At the same time, the speaker 13 makes a dialing sound similar to the conventional dialing sound of a telephone.

Step 205: Receive all moving signals. The process then ends successfully. By configuring as above, a user can achieve the purpose of dialing by means of the control button 11 and the virtual disk 121.

In addition, the invention can be applied to English and Chinese input for users preferring using a single hand in operation. Its principle is the same as the above digit input. That is, the invention simulates the input of an alphanumeric keypad of a conventional mobile phone by utilizing the touch sensitive rotary arrangement of the control button 11. As a result, input is achieved. For example, in addition to the “origin” 124 on the virtual disk 121 each of a plurality of fixed marks (including ten numerals and two special characters) shown on the periphery of the virtual disk 121 corresponds to a corresponding one of 12 keys of the conventional mobile phone. This means that it is identical to the conventional telephone dial. Therefore, the operation habit of users can be maintained with novel features being added.

Alternatively, the original alphanumeric keypad is replaced with alphabets and/or characters. For example, English letters, Chinese characters, and Mandarin phonetic symbols can be inputted by simulating data input by means of keypad.

While the invention herein disclosed has been described by means of specific embodiments, numerous modifications and variations could be made thereto by those skilled in the art without departing from the scope and spirit of the invention set forth in the claims.

What is claimed is:

1. An input method for a portable electronic device, which includes a control button and a screen, comprising the steps of:
showing a virtual disk on the screen, when the portable electronic device entering a disk dialing mode, wherein the virtual disk includes a plurality of fixed marks along its periphery, each of the fixed marks representing a numeral, a character, or a letter;
in response to receiving a movement signal inputted by the control button, moving a moving mark on the periphery of the virtual disk from the fixed mark labeled as an origin to a location desired by the user along the fixed marks; and
in response to receiving a confirmation signal inputted by the control button, activating a corresponding one of the fixed marks to generate a corresponding numeral, character or letter, and returning the moving mark to the fixed mark labeled as an origin after traversing the periphery of the virtual disk.

2. The input method of claim 1, in response to returning the moving mark to the fixed mark labeled as an origin after traversing the periphery of the virtual disk, further comprising the step of making a dialing sound by a speaker of the portable electronic device.

3. The input method of claim 1, when a hot key of the portable electronic device being pressed, further comprising the step of causing the portable electronic device to enter the disk dialing mode.

4. An input arrangement for a portable electronic device comprising:
a phone body having a software installed therein, the software adapted to perform a disk dialing mode;
a screen on the phone body adapted to show a virtual disk thereon in response to performing the disk dialing mode wherein the virtual disk includes a plurality of fixed marks along its periphery, each of the fixed marks representing a numeral, a character, or a letter; and
a control button on the phone body for inputting a movement signal to move a moving mark on the periphery of the virtual disk from the fixed mark labeled as an origin to a location desired by a user along the fixed marks, and for inputting a confirmation signal to activate a corresponding one of the fixed marks to generate a corresponding numeral, character, or letter, and return the moving mark to the fixed mark labeled as an origin after traversing the periphery of the virtual disk.

5. The input arrangement of claim 4, wherein the control button is a spherical member and comprises four direction keys for inputting the movement signal and a central confirmation key for inputting the confirmation signal.

6. The input arrangement of claim 5, wherein the control button is a touch sensitive rotary member.

7. The input arrangement of claim 4, wherein the portable electronic device is a pocket PC phone.

8. The input arrangement of claim 7, wherein the portable electronic device is a pocket PC phone connectable to a mobile phone.

9. The input arrangement of claim 4, wherein the portable electronic device further comprises a speaker which, in response to returning the moving mark to the fixed mark labeled as an origin after traversing the periphery of the virtual disk, is adapted to make a dialing sound.

10. The input arrangement of claim 4, wherein the portable electronic device further comprises a hot key adapted to run the software to enter the disk dialing mode when being pressed.
